(19) United States
(12) Patent Application Publication
(10) Pub. No.: US 2023/0406392 A1
(43) Pub. Date: Dec. 21, 2023

(54) SNOWMOBILE STEERING ASSEMBLY AND SNOWMOBILE HAVING THE SAME

(71) Applicant: Luc David Kazimirski, Squamish (CA)

(72) Inventor: Luc David Kazimirski, Squamish (CA)

(21) Appl. No.: 17/844,173

(22) Filed: Jun. 20, 2022

(51) Int. Cl. B62B 13/12; B62M 27/02

(52) U.S. Cl. CPC B62B 13/12; B62M 27/02

(57) ABSTRACT

There is provided a snowmobile steering assembly according to one aspect. The snowmobile steering assembly includes at least one ski having a pair of side edge portions which are outwardly concave. The snowmobile steering assembly includes a mount which pivotally couples to the ski and rotates the ski about an axis generally parallel to or slightly angled relative to a forward portion of the ski.

There is also provided a snowmobile steering assembly according to another aspect. The snowmobile steering assembly includes a steering mechanism. The steering mechanism is configured to primarily turn the snowmobile by angling the top of the ski at least in part towards the direction of the turn. The steering mechanism is configured to secondarily turn the snowmobile by rotating a forward portion of ski in the direction of the turn.

### BACKGROUND OF THE INVENTION

### Field of the Invention

There is provided a steering assembly. In particular, there is provided a snowmobile steering assembly, and a snowmobile having the same.

### Description of the Related Art

U.S. Pat. No. 7,487,975 to Pryputniewicz discloses a quad parabolic snowmobile ski. The ski includes an elongated body having a top side, a bottom side, a tip at the front end, a rear end, a pair of symmetrically opposed ski parabolic cutting edges disposed longitudinally along the bottom of the ski, and a keel. The keel is attached to the bottom of the ski and has a central median ridge, i.e., a keel rail, a substantial portion of which protrudes below the bottom of the ski to form a central and longitudinal point of contact with the snow. The keel defines symmetrically opposed snow-funneling channels along the opposite sides of the central median ridge. Varying radii of curvature of the channels form parabolically-shaped channel outer sidewalls. Symmetrically opposed keel parabolic cutting edges are formed by contouring a keel body width to follow the contour of the parabolic shaped outer sidewalls at a constant cutting edge width.

U.S. Pat. No. 7,017,695 to Meunier et al. discloses a snow ski pivotally attached to a snowmobile in order for it to be pivotable about its longitudinal, steering and transversal axes that intersect each other. The ski has a ski sole from which integrally project first and second elongated front lateral keels and an elongated rear central keel. Moreover, rear ski sole depressions are made in the ski sole, at the vicinity of the rear keel. When the ski is in a straight-line position for allowing the snowmobile to move forward in a straight line, it adopts a flat ground-engaging position in which all three keels rest on the ground surface. When the ski is in a turn-carving position for allowing the snowmobile to move forward while turning in a desired direction, the ski is tilted sidewardly with only the central keel and a selected one of the first and second lateral keels resting on the ground, to carve the ground surface in order for the ski to exhibit a self-steering behavior with enhanced gripping effect. When the ski is in this turn-carving position, the ski sole may be prevented from engaging the ground due to the rear ground clearance of the ski sole, even though the ski may become tilted about its longitudinal, steering and transversal axes.

U.S. Pat. No. 6,199,649 to Alanko discloses a snowmobile ski suspension. The snowmobile ski suspension has two parallel front mounted steerable skis. Each ski is steerable by rotation of the trailing suspension arms about a frame mounted bearing forward of the center of the ski. Steering input from the handlebar rotates the suspension and the ski. The ski moves laterally towards the outside of a turn during rotation to provide increased cornering stability. The ski has a keel mounted forward of its center for ease of turning. The dual support steering column provides a forward offset for the handlebar which may lean the driver toward the inside of a corner for better balance and which may provide crash protection.

### BRIEF SUMMARY OF INVENTION

There is provided, and it is an object to provide, an improved snowmobile steering assembly.

There is accordingly provided a snowmobile steering assembly according to one aspect. The steering assembly includes at least one ski spanning a plane. The ski has a pair of side edge portions which are outwardly concave. The steering assembly includes a mount which pivotally couples to the ski at a pivot point and rotates the ski about an axis which intersects with the plane forward of the at least one ski when the ski extends horizontally.

There is also provided a snowmobile steering assembly according to another aspect. The steering assembly includes at least one ski having a longitudinal axis and a pair of side edge portions which are outwardly concave. The steering assembly includes a steering mechanism pivotally coupling to the ski at a pivot point and rotating the ski about an axis generally parallel or slightly angled relative to the longitudinal axis of the ski when the ski extends horizontally.

There is further provided a snowmobile steering assembly according to a further aspect. The steering assembly includes at least one ski spanning a plane. The ski has a pair of side edge portions which are outwardly concave. The steering assembly includes an elongate member coupling to and extending at least in part upwards from the ski when the ski extends horizontally. The steering assembly includes a steering mechanism to which the elongate member pivotally couples about an axis perpendicular to the elongate member.

There is also provided a snowmobile steering assembly according to another aspect. The steering assembly includes at least one ski spanning a plane. The ski has a pair of side edge portions which are outwardly concave. The steering assembly includes an elongate member coupling to and extending at least in part upwards from the ski. The steering assembly includes a steering mechanism to which the elongate member pivotally couples about an axis parallel to or intersecting with the plane forward of the elongate member when the ski extends horizontally.

There is additionally provided a snowmobile steering assembly according to yet another aspect. The steering assembly includes at least one ski spanning a plane. The ski has a pair of side edge portions which are outwardly concave. The steering assembly includes an elongate member fixedly coupled to and extending upwards and forwards from the ski when the ski extends horizontally. The steering assembly includes a steering mechanism to which the elongate member pivotally couples.

There is also provided a snowmobile steering assembly according to yet a further aspect. The steering assembly includes at least one ski having a longitudinal axis and a pair of side edge portions which are outwardly concave. The steering assembly includes a steering mechanism configured to primarily turn the snowmobile by rotating the ski about the longitudinal axis. The steering mechanism is configured to secondarily turn the snowmobile by rotating a forward portion of ski in the direction of the turn about a vertical axis

There is further provided a snowmobile steering assembly according to yet an additional aspect. The steering assembly includes at least one ski having a longitudinal axis and a pair of side edge portions which are outwardly concave. The steering assembly includes a ski leg coupled to and extending upwards from the ski. The steering assembly includes a mount to which the ski leg pivotally couples to enable the ski to rotate about an axis of rotation parallel or slightly angled relative to the longitudinal axis of the ski when the ski extends horizontally. The steering assembly includes a steering member rotatably coupled to the snowmobile. The steering assembly includes a linkage assembly configured to translate rotation of the steering member to rotation of the ski about said axis of rotation.

There is yet also provided a snowmobile steering assembly according to a further aspect. The steering assembly includes at least one ski having a pair of side edge portions which are outwardly concave. The steering assembly includes a steering mechanism pivotally coupled to the ski. The steering mechanism is configured to promote steering in a first direction by both slightly rotating the ski towards the first direction and slightly angling a forward portion of the ski towards the first direction. The steering mechanism is configured to promote steering in a second direction opposite the first direction, by both slightly rotating the ski towards the second direction and slightly angling the forward portion of the ski towards the second direction.

There is further provided a snowmobile steering assembly according to yet an additional aspect. The steering assembly includes at least one ski having a longitudinal axis. The ski has a pair of side edge portions which are outwardly concave and a top extending between said edge portions thereof. The steering assembly includes a steering mechanism configured to primarily turn the snowmobile by angling the top of the ski at least in part towards the direction of the turn. The steering mechanism is configured to secondarily turn the snowmobile by rotating a forward portion of ski in the direction of the turn.

There is also provided a snowmobile steering assembly according to another aspect. The steering assembly includes at least one ski extending along a longitudinal axis. The ski has a pair of side edge portions which are outwardly concave. The steering assembly includes a steering mechanism coupling to the ski about an axis of rotation so as to cause the ski to incline towards respective one of the side edge portions thereof.

There is yet also provided a snowmobile steering assembly according to yet another aspect. The steering assembly includes at least one ski extending along a longitudinal axis. The ski has a pair of side edge portions which are outwardly concave. The steering assembly includes a steering mechanism coupling to the ski about an axis of rotation that causes the ski to incline such that the side edge portion thereof opposite a direction of turn rises upwards and causes a forward portion of the ski to angle in part towards the direction of the turn.

There is also provided a snowmobile including one or more of the above set out steering assemblies.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a left side perspective view of a snowmobile including a steering assembly shown in fragment and according to one aspect, the snowmobile having an outer shell that is partially removed, and the steering assembly including a handlebar, a steering column coupled to the handlebar and rotatably mounted to framing of the snowmobile, a pitman arm coupled to a distal end of the steering column, and a steering linkage coupled to the pitman arm via a proximal end thereof;

FIG. 2 is a left side perspective view of the snowmobile and steering assembly thereof of FIG. 1, with the snowmobile and steering assembly being shown in fragment, with the steering assembly including a steering shaft rotatably mounted to framing of the snowmobile, and with the steering assembly including a first crank coupled to a proximal end of the steering shaft, the steering linkage pivotally couples to the first crank via a distal end thereof;

FIG. 3 is a left side perspective view of the snowmobile and steering assembly thereof FIG. 2, with the snowmobile and steering assembly being shown in fragment, with the steering assembly including a second crank coupled to a distal end of the steering shaft, and with the steering assembly including a drag link coupled pivotally to the second crank via a proximal end thereof;

FIG. 4 is a left side perspective view of the snowmobile and steering assembly thereof FIG. 3, with the snowmobile and steering assembly being shown in fragment, with the steering assembly including a ski leg mount and a first bell crank pivotally coupled thereto, the first bell crank pivotally coupling to a distal end of the drag link via a first arm thereof;

FIG. 5 is a left side, rear, top perspective view of the snowmobile and steering assembly thereof FIG. 4, with the snowmobile and steering assembly being shown in fragment, with the steering assembly including a second bell crank spaced-apart below the first bell crank and pivotally coupled to the mount, with the steering assembly including at least one parabolic ski pivotally coupled to a respective said mount via a first arm of the second bell crank, and with the steering assembly including a rectilinear member which pivotally couples together second arms of the bell cranks;

FIG. 6 is a schematic, left side, top perspective view of the ski, second bell crank and mount of the steering assembly of FIG. 5, illustrating that the ski is pivotally coupled to the mount such that the axis of rotation of the ski is slightly angled so as to intersect with a plane of the ski forward of the mount when the ski extends horizontally;

FIG. 7 is a schematic top plan view of the ski of FIG. 5;

FIG. 8 is a schematic front elevation view of the ski thereof shown with a bottom thereof shown extending substantially flush with a snow surface;

FIG. 9 is a left side, rear, top perspective view of the snowmobile and steering assembly thereof FIG. 5, with the snowmobile and steering assembly being shown in fragment, with the steering assembly shown in the process of turning in a first or right-hand direction, with the drag link shown in an extended position, causing the bell cranks to rotate in a first direction of rotation so as to cause a right side edge portion of the ski to angle downwards into the snow and cause a left side edge portion of the ski to incline upwards from the snow;

FIG. 10 is a front elevation view of the ski of FIG. 9 shown in fragment;

FIG. 11 is a schematic, left side elevation view of the ski of FIG. 9 shown in fragment;

FIG. 12 is a schematic, left side elevation view of the ski of FIG. 9 shown in fragment, illustrating that the steering assembly so coupled to the ski causes the ski to rotate slightly about a vertical axis towards the right-hand direction when the steering assembly is in the process of turning in the right-hand direction of FIG. 9;

FIG. 13 is a left side, rear, top perspective view of the snowmobile and steering assembly thereof FIG. 5, with the snowmobile and steering assembly being shown in fragment, with the steering assembly shown in the process of turning in a second or left-hand direction, with the drag link shown in a retracted position, causing the bell cranks to rotate in a second direction of rotation so as to cause the left side edge portion of the ski to angle downwards into the snow and cause the right side edge portion of the ski to incline upwards from the snow;

FIG. 14 is a schematic front elevation view of the ski of FIG. 13;

FIG. 15 is a schematic, left side elevation view of the ski of FIG. 13 shown in fragment;

FIG. 16 is a schematic, left side elevation view of the ski of FIG. 13 shown in fragment, illustrating that the steering assembly so coupled to the ski causes the ski to rotate slightly about the vertical axis towards the left-hand direction when the steering assembly is in the process of turning in the left-hand direction of FIG. 13;

FIG. 17 is a schematic front elevation view of a snowmobile and steering assembly according to another aspect, with the snowmobile and steering assembly being shown in fragment and the snowmobile being shown in a straight position; and

FIG. 18 is a schematic front elevation view of the snowmobile and steering assembly of FIG. 17, with the snowmobile and steering assembly being shown in fragment and the snowmobile being shown in the process of steering in the left-hand direction.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

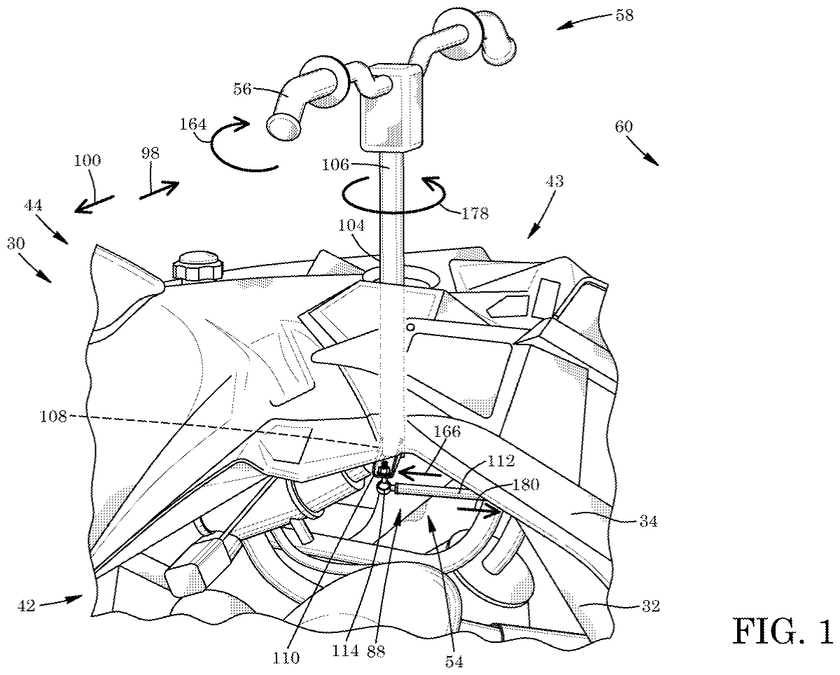

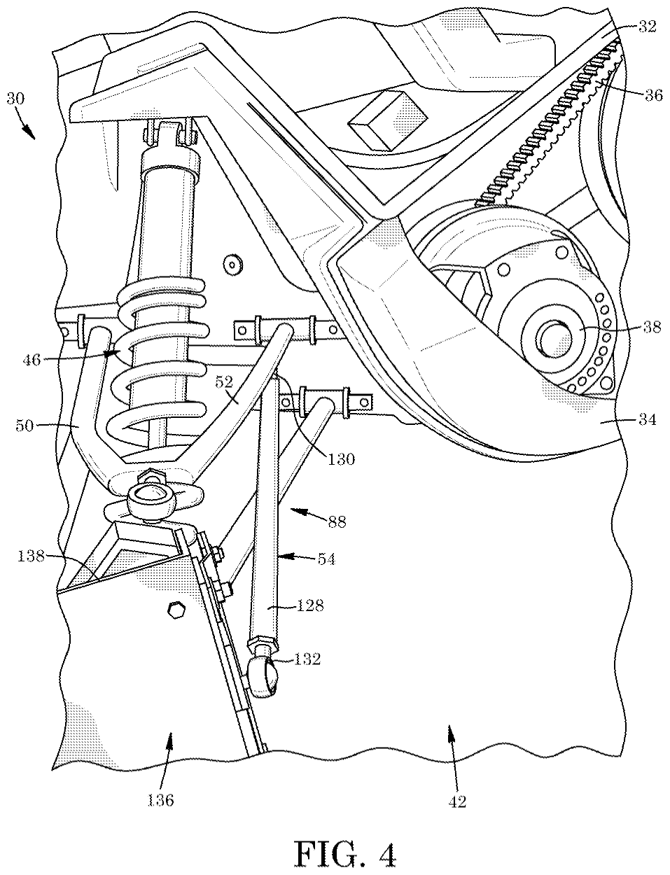

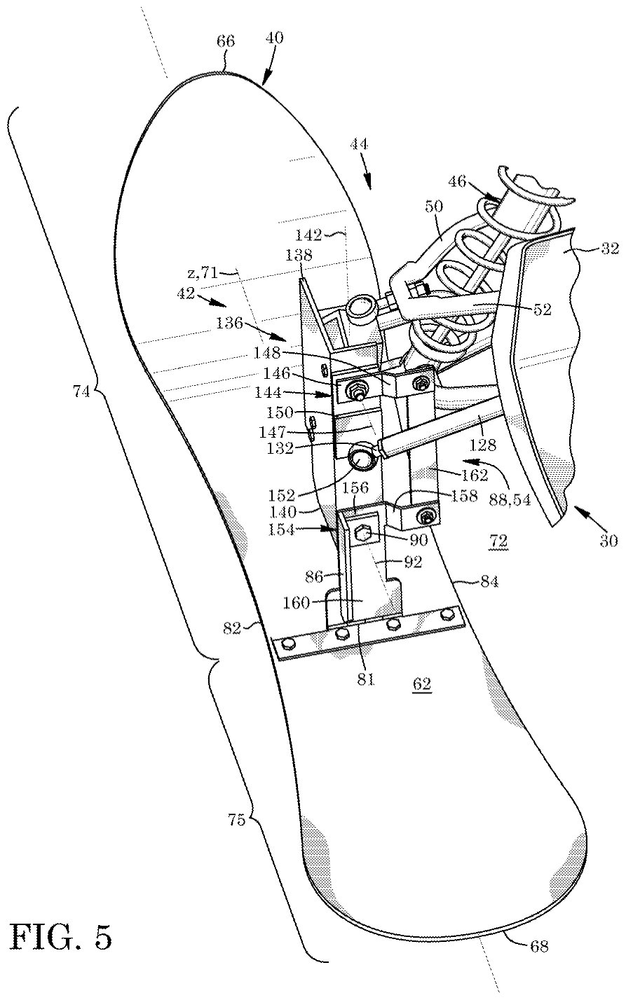

Referring to the drawings and first to FIG. 1, there is shown a snowmobile 30. The snowmobile includes framing 32 and an outer shell 34 which extends at in least part about the framing thereof. As seen in FIG. 4, snowmobile 30 includes a continuous belt-type track 36 rotatably coupled to the framing and an engine, in this example a combustion engine 38 mounted to the framing. The engine operatively couples to the belt-type track to selectively rotates the belt-type track and cause the snowmobile to move forwards or rearwards. As seen in FIG. 1, snowmobile 30 has a left side 42, right side 43 and a front 44. As seen in FIG. 5, the snowmobile includes at least one and in this example a pair of skis pivotally coupled to framing 32 thereof adjacent the front thereof, as seen by left side ski 40.

As seen in FIG. 4, snowmobile 30 includes a front suspension system 46 comprising a spring-loaded suspension strut 46 and a pair of arms or radius rods 50 and 52 on each side 42 thereof. The strut and radius rods extend between pivotally couple to a respective ski 40 and framing 32. Any suitable suspension mechanism may be provided for the snowmobile instead of that shown and described without departing from the scope and spirit of the invention.

As seen in FIG. 1, snowmobile 30 includes a snowmobile steering assembly 54. The steering assembly includes a steering member, in this example a handlebar 56 adjacent the top 58 of the snowmobile between front 44 and rear 60 of the snowmobile. The snowmobile described to this point is conventional. Snowmobiles per se, including their various parts and functionings, are well known to those skilled in the art and therefore will not be described in further detail.

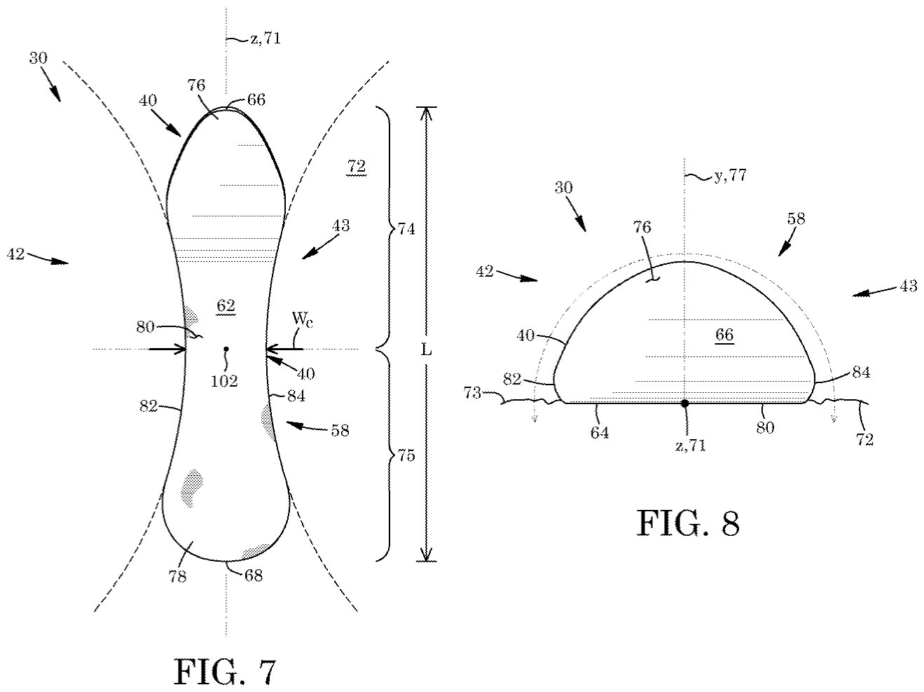

As seen in FIG. 7, each ski 40 is parabolic and may be said to be part of the steering assembly 54. Each ski has a top 62 and a bottom 64 seen in FIG. 8 spaced-apart from the top thereof. Referring back to FIG. 7, each ski 40 has a front 66 and a rear 68 spaced-apart from the front thereof. Each ski extends along a longitudinal or z axis and spans a plane 72. When handlebar 56 seen in FIG. 1 is a non-turning or straight position, bottoms 64 of skis 40 and the plane of the skis extend substantially flush with snow or ground 73 seen in FIG. 8, which is generally horizontal in this example. When the handlebar is a non-turning or straight position, z axis of skis 40 align parallel with the longitudinal axis 71 of the snowmobile, which has been transposed to be coaxial with the z axis of the ski for explanation purposes. As seen in FIG. 8, each ski has a vertical or y axis that extends upwards from and perpendicular to z axis thereof. The vertical axis of ski aligns with a plane extending perpendicular to and upwards from ground 73, in this example vertical plane 77.

As seen in FIG. 7, each ski includes a forward portion 74 that extends from front 66 thereof towards rear 68 thereof and includes a rearward portion 75 that extends from the rear thereof towards the front thereof.

Each ski 40 has a front portion or tip 76 adjacent the front thereof, a rear portion or tail 78 adjacent the rear thereof and a central portion 80 between the tip and the tail thereof. The tip of the ski is outwardly convex in top/bottom profile in this example. As seen in FIG. 8, tip 76 of ski 40 extends upwards relative to central portion 80 and plane 72 of the ski. The tip of the ski is outwardly convex in front profile in this example. As seen in FIG. 7, tail 78 of the ski is outwardly convex in top/bottom profile in this example, though this is not strictly required.

Still referring to FIG. 7, each ski includes a left-side longitudinal edge portion 82 and a right side longitudinal edge portion 84 spaced-apart from the first longitudinal edge portion thereof. The longitudinal edge portions of the skis extend between tip 76 and tail 78 of the skis. Longitudinal edge portion 82 of ski 40 is outwardly concave in top/bottom profile and faces towards left side 42 of snowmobile 30. Longitudinal edge portion 84 of the ski is outwardly concave in top/bottom profile and faces towards right side 43 of the snowmobile. Longitudinal edge portions 82 and 84 of skis 40 have the same radius of curvature in this example; however, this is not strictly require.

As seen in FIG. 5, steering assembly 54 includes a ski leg 86 in this example coupled to each respective ski 40. Each ski leg couples to a respective central portion 80 of the ski between forward portion 74 and rearward portion 75 of the ski, in this example pivotally coupling to the central portion of the ski, in this case via hinge 81. The hinge is configured to allow movement of the ski in the zy plane. Each ski leg 86 couples to and extends upwards from its respective ski 40. Each ski leg is centrally positioned between longitudinal edge portions 82 and 84 of the ski in this example. However, this is not strictly required and the ski leg may be closer to one longitudinal edge portion 82 relative to the other longitudinal edge portion 84 or vice versa, for example. Each ski leg 86 aligns with z axis of ski 40 in this example.

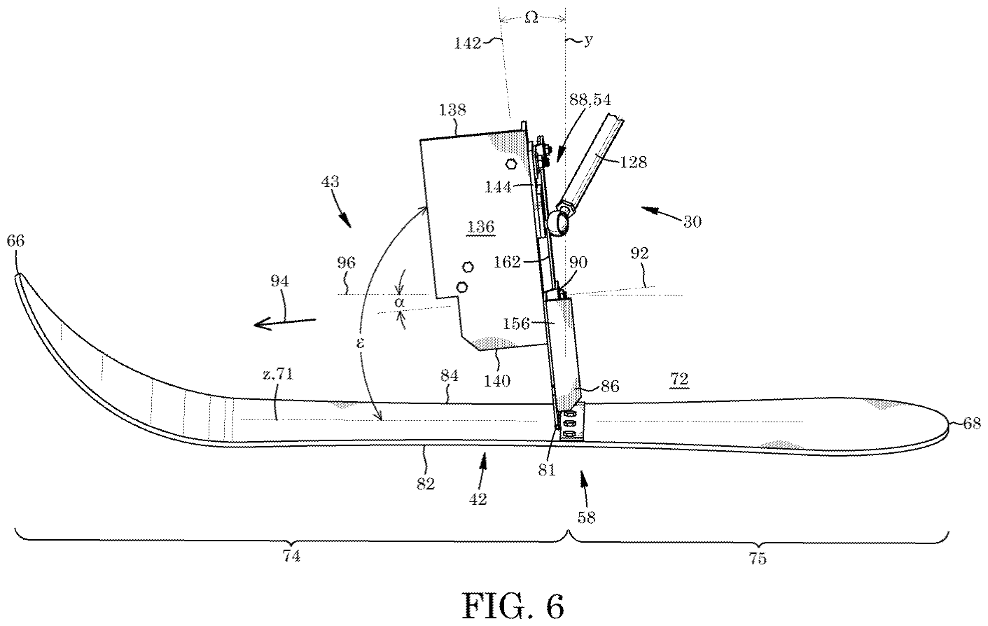

Still referring to FIG. 5, steering assembly 54 includes a steering mechanism 88. The steering mechanism pivotally couples to ski 40 at a pivot point 90. As seen in FIG. 6, steering mechanism 88 pivotally couples to the ski about an axis of rotation 92 which intersects with the plane of the ski forward of the steering mechanism in this example. The axis of rotation is generally parallel but slightly angled relative to z axis of ski 40 in this example when the ski extends horizontally or relative to the longitudinal axis of the snowmobile. Axis of rotation 92 angles towards and intersects with the z axis in the forward direction 94 when the ski extends horizontally. The axis of rotation extends generally horizontally, in this example at a slight angle relative to the horizontal plane 96, in this case by an angle α as seen in FIG. 6.

As seen in FIGS. 5, 9 and 13, steering mechanism 88 is configured to enable each ski 40 to selectively rotate about axis of rotation 92 towards right side edge portion 84 of the ski or left side edge portion 82 of the ski. The steering mechanism is configured to translate rotation of handlebar 56 seen in FIG. 1 to rotation of skis 40 about said axes of rotation 92 seen in FIGS. 5, 9 and 13.

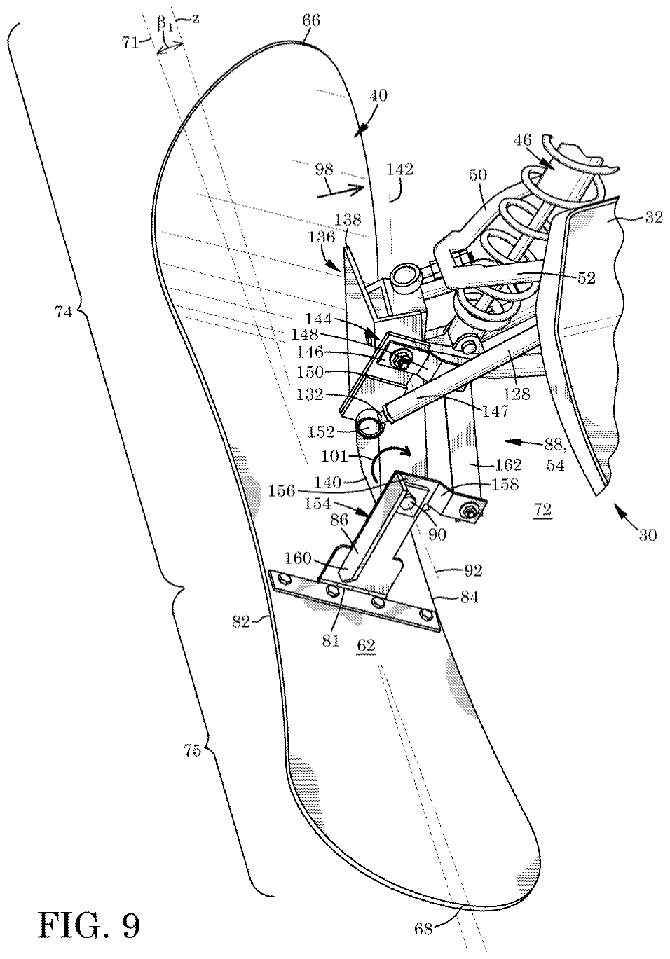

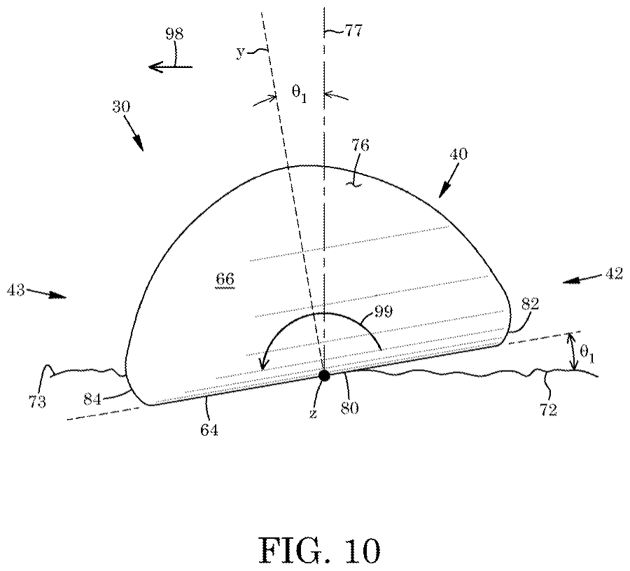

As seen in FIG. 9, steering mechanism 88 is configured to promote steering in a first or right direction 98 by both i) slightly inclining the ski towards the right direction such that right side edge portion 84 seen in FIG. 10 abuts ground 73 and left side edge portion 82 is spaced upwards from the snow and ii) slightly angling forward portion 74 of the ski towards the right direction as seen in FIG. 9. As seen in FIG. 10, ski 40 and y axis thereof rotate about a first direction of rotation, in this example a clockwise direction of rotation 99. They axis of the ski is angularly spaced by an angle θ₁ relative to vertical plane 77. Angle θ₁ is acute in this example. Angle θ₁ may be equal to or less than 45 degrees in one example, with the ski being tiltable relative to vertical plane 77 by up to this extent in either direction thereof and in the range of equal to or greater than −45 degrees and equal to and less than 45 degrees. In another embodiment, angle θ₁ may be 30 degrees, with the ski being tiltable relative to the vertical plane by up to this extent in either direction and in the range of equal to or greater than −30 degrees and equal to and less than 30 degrees. In a further embodiment, angle θ₁ may be 15 degrees, with the ski being tiltable relative to vertical plane 77 by up to this extent in either direction and in the range of equal to or greater than −15 degrees and equal to and less than 15 degrees. However, this is not strictly required and angle θ₁ may be greater than 45 degrees and less than 90 degrees in other examples, or less than 15 degrees in yet further embodiments.

As seen in FIG. 9, the rotation of forward portion 74 of ski 40 is shown by z axis of the forward portion of ski 40 being angled inwards in a forward direction by an angle β₁ relative to longitudinal axis 71 of snowmobile 30. Angle β₁ is acute in this example. This enables skis 40 to generally remain adjacent framing 32 of the snowmobile throughout the turning process, thus inhibiting the extent to which the skis extend outwards therefrom. Angle β₁ may be equal to or less than 45 degrees in one example, with the ski being angled relative to relative to longitudinal axis 71 by up to this extent in either direction thereof and in the range of equal to or greater than −45 degrees and equal to and less than 45 degrees. In another embodiment, angle β₁ may be 30 degrees, with the ski being angled relative to longitudinal axis 71 by up to this extent in either direction and in the range of equal to or greater than −30 degrees and equal to and less than 30 degrees. In a further embodiment, angle β₁ may be 15 degrees, with the ski being angled relative to longitudinal axis 71 by up to this extent in either direction and in the range of equal to or greater than −15 degrees and equal to and less than 15 degrees. However, this is not strictly required and angle β₁ may be greater than 45 degrees and less than 90 degrees in other examples, or less than 15 degrees in yet further embodiments.

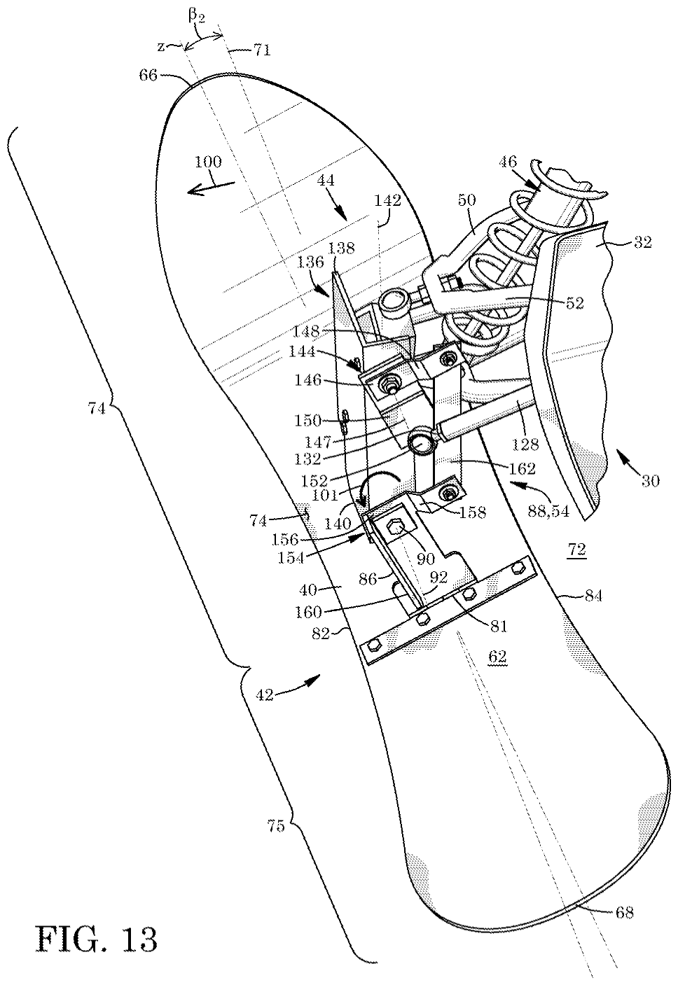

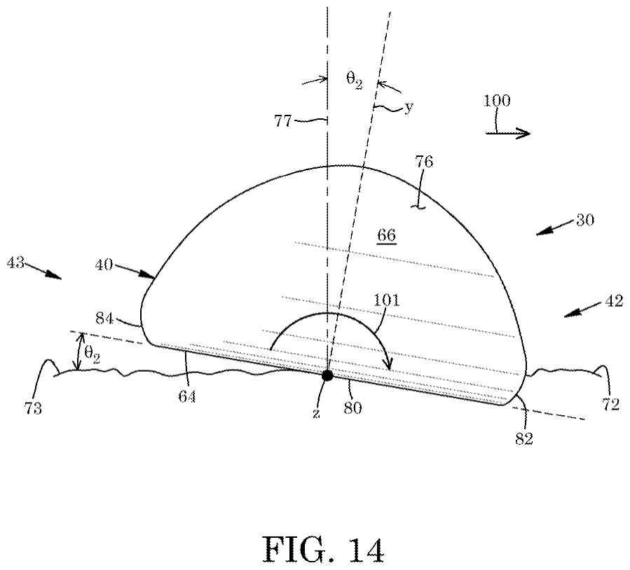

As seen in FIG. 13, steering mechanism 88 is configured to promote steering in a second or left direction 100 opposite the right direction 98 seen in FIG. 9. Referring back to FIG. 13, the steering mechanism is configured to promote steering towards the left direction by both i) slightly inclining the ski towards the left direction such that left side edge portion 82 seen in FIG. 14 abuts ground 73 and right side edge portion 84 is spaced upwards from the snow and ii) slightly angling forward portion 74 of the ski towards the left direction as seen in FIG. 13.

As seen in FIG. 14, ski 40 and y axis thereof rotate about a second direction of rotation opposite the first direction of rotation, in this example in a counter-clockwise direction of rotation 101. The y axis of the ski is angularly spaced by an angle θ₂ relative to vertical plane 77. Angle θ₂ is acute in this example. Angle θ₂ may be equal to or less than 45 degrees in one example, with the ski being tiltable relative to vertical plane 77 by up to this extent in either direction thereof and in the range of equal to or greater than −45 degrees and equal to and less than 45 degrees. In another embodiment, angle θ₂ may be 30 degrees, with the ski being tiltable relative to the vertical plane by up to this extent in either direction and in the range of equal to or greater than −30 degrees and equal to and less than 30 degrees. In a further embodiment, angle θ₂ may be 15 degrees, with the ski being tiltable relative to vertical plane 77 by up to this extent in either direction and in the range of equal to or greater than −15 degrees and equal to and less than 15 degrees. However, this is not strictly required and angle θ₂ may be greater than 45 degrees and less than 90 degrees in other examples, or less than 15 degrees in yet further embodiments.

As seen in FIG. 13, the rotation of forward portion 74 of ski 40 is shown by z axis of the forward portion of ski 40 being angled outwards in a forward direction by an angle (32 relative to longitudinal axis 71 of snowmobile 30. Angle (32 is acute in this example. This enables skis 40 to generally remain adjacent framing 32 of the snowmobile throughout the turning process, thus inhibiting the extent to which the skis extend outwards therefrom. Angle (32 may be equal to or less than 45 degrees in one example, with the ski being angled relative to relative to longitudinal axis 71 by up to this extent in either direction thereof and in the range of equal to or greater than −45 degrees and equal to and less than 45 degrees. In another embodiment, angle (32 may be 30 degrees, with the ski being angled relative to longitudinal axis 71 by up to this extent in either direction and in the range of equal to or greater than −30 degrees and equal to and less than 30 degrees. In a further embodiment, angle (32 may be 15 degrees, with the ski being angled relative to longitudinal axis 71 by up to this extent in either direction and in the range of equal to or greater than −15 degrees and equal to and less than 15 degrees. However, this is not strictly required and angle (32 may be greater than 45 degrees and less than 90 degrees in other examples, or less than 15 degrees in yet further embodiments.

Steering mechanism 88 is thus configured to primarily turn snowmobile 30 by selectively rotating skis 40 generally in the direction of the turn and at least in part about the z axis of the ski. The steering mechanism is configured to secondarily turn the snowmobile by rotating forward portion 74 of ski in the direction of the turn about vertical axis 102 of the ski seen in FIG. 7. Steering mechanism 88 may be referred to as a linkage assembly configured to translate rotation of handlebar 56 into rotation of ski 40 about the axis of rotation 92 seen in FIG. 9.

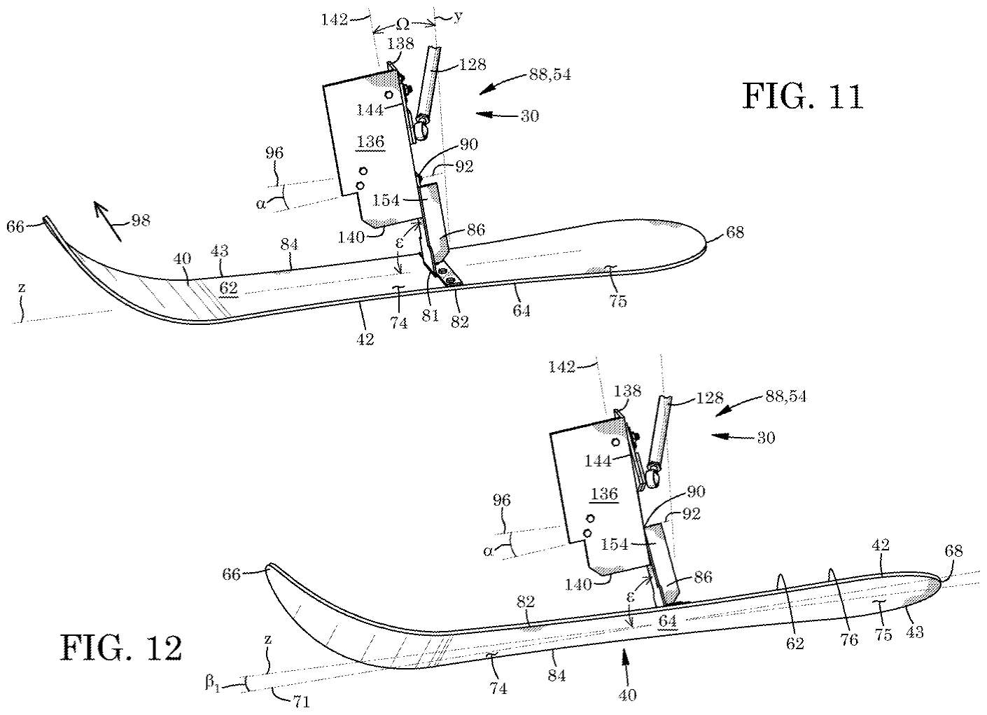

Referring to FIG. 11, the extent to which axis of rotation 92 is angled relative to the horizontal plane 96, in this case by an angle α, will determine the extent to which the forward portions 74 of skis 40 will angle outwards in a forward direction by angle β₁ relative to longitudinal axis 71 of snowmobile 30 seen in FIG. 9. Thus, the larger angle α seen in FIG. 11, the larger is the turning of the skis relative to the vertical axis and the larger is angle β₁ Positioning of axis of rotation 92 seen in FIG. 11 and so angled by angle α, causes rotation about the y axis that is conducive to steering mechanism 88.

The following a non-limiting example of one said steering mechanism 88 which enables the above features and functionality, though those skilled in the art will appreciate that other types of specific embodiments and associated linkage assemblies may be provided in other examples.

As seen in FIG. 1, the steering mechanism includes a steering column 104 rotatably mounted to framing 32 of snowmobile 30. The steering column has a proximal end 106 and a distal end 108 spaced-apart from the proximal end thereof. Steering column 104 couples to handlebar 56 via the proximal end thereof. Steering mechanism 88 includes a steering component, in this example a pitman arm 110. The pitman arm couples to and extends radially outwards from distal end 108 of steering column 104.

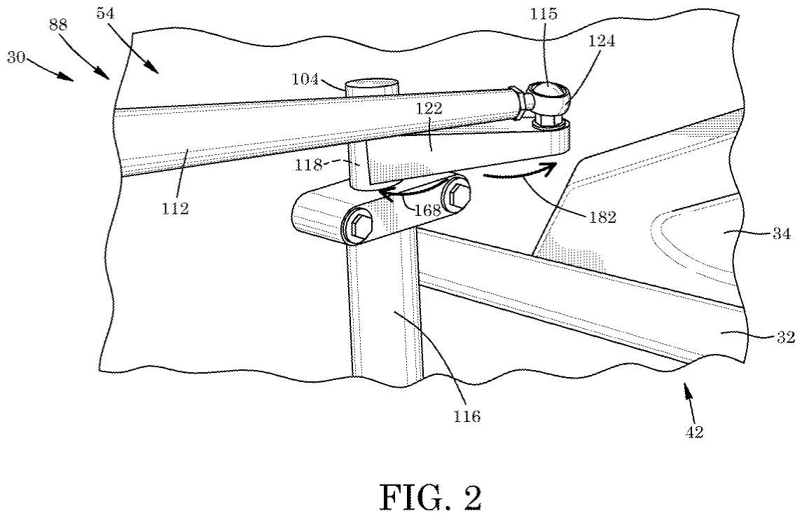

Steering mechanism 88 includes a steering linkage 112. The steering linkage has a proximal end and a distal end 115 (seen in FIG. 2) spaced-apart from the proximal end thereof. Referring back to FIG. 1, steering linkage 112 pivotally couples to pitman arm 110 via the proximal end thereof, in this example via a ball joint 117; however, the latter is not strictly required.

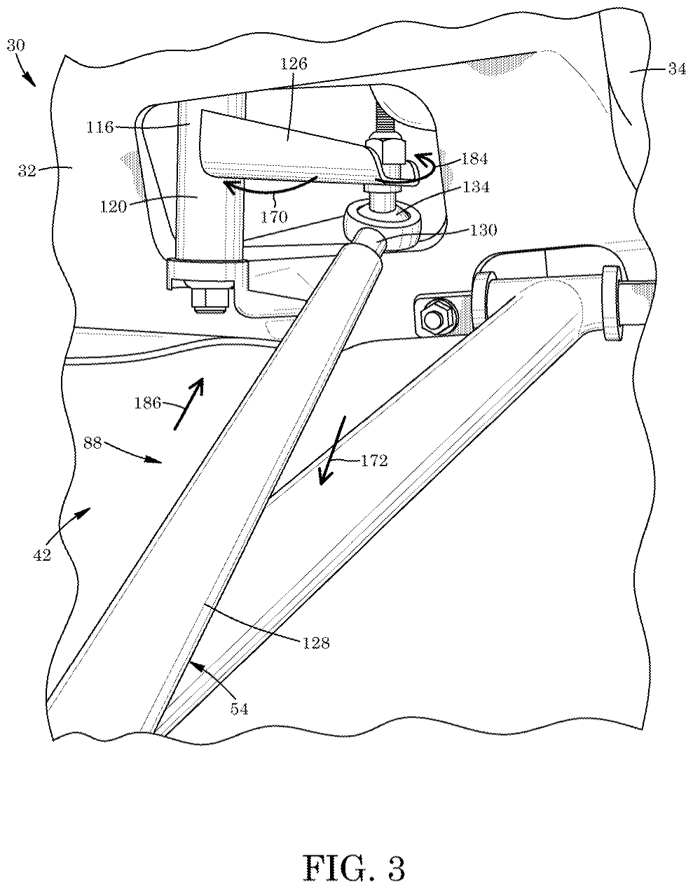

As seen in FIG. 2, steering mechanism 88 includes a steering shaft 116. The steering shaft is rotatably mounted to framing 32 of snowmobile 30. Steering shaft 116 has a proximal end portion 118 and a distal end portion 120 (seen in FIG. 3) spaced-apart from the distal end portion thereof. Referring back to FIG. 2, steering mechanism 88 includes a first crank 122. The first crank couples and extends radially outwards from proximal end portion 118 of steering shaft 116. Steering linkage 112 pivotally couples to first crank 122 via distal end 115 thereof, in this example via a ball joint 124; however, the latter is not strictly required.

As seen in FIG. 3, steering mechanism 88 includes a second crank 126 spaced-apart from the first crank thereof seen in FIG. 2. Referring back to FIG. 3, the second crank couples to and extends radially outwards from distal end portion 120 of steering shaft 116. Steering mechanism 88 includes a linking member per side 42 of snowmobile 30, in this example a drag link 128. As seen in FIG. 4, the drag link has a proximal end 130 and a distal end 132 spaced-apart from the proximal end thereof. Drag link 128 pivotally couples to second crank via the proximal end, in this example via a ball joint 134; however, the latter is not strictly required.

As seen in FIG. 5, steering assembly 54 in this embodiment includes an elongate member on each side 42 of snowmobile for each respective ski 40, in this example an elongate mount, in this case a ski leg mount 136; however, this is not strictly required and the steering mechanism may pivotally couple to the ski in other manners in other examples. The ski leg mount is L-shaped in top/bottom profile and in the form of an angle bar in this example; however, here too this is not strictly required for pivotably coupling with the ski. As seen in FIG. 6, ski leg mount 136 has a proximal end 138, a distal end 140 spaced-apart from the proximal end thereof and a longitudinal axis 142 extending between the ends thereof. As seen in FIG. 5, the ski leg mount pivotally couples to framing 32 via front suspension system 46 in this example.

Referring back to FIG. 6, each ski leg mount 136 extends upwards and forwards at least in part from its corresponding ski 40 in this example; however, this is not strictly required. Longitudinal axis 142 of the ski leg mount is at least slightly angled relative to the vertical axis and y axis of ski 40 in this example when the ski extends horizontally; however, this too is not strictly required. Ski leg mount 136 is angularly spaced forwards in an upwards direction relative to y axis of the ski by an angle Ω when the ski extends in the horizontal direction. Angle Ω is acute in this example. Angle Ω is greater than 0 degrees and equal to or less than 45 degrees and acute in one example. Angle Ω is greater than 0 degrees and equal to or less than 30 degrees another example. Angle Ω is approximately equal 15 degrees in a further non-limiting example.

As seen in FIG. 6, ski leg mount 136 is angularly spaced apart from forward portion 74 of ski 40 by an angle ε which is non-perpendicular in this example. Angle ε is greater than 0 degrees and less than 90 degrees and acute in one example. Angle ε is greater than 45 degrees and less than 90 degrees another example. Angle ε is approximately equal 75 degrees in a further non-limiting example. Ski leg 86 is also so angled in this example; however this is not strictly required.

Ski 40 pivotally couples to ski leg mount 136 about axis of rotation 92 which intersects with plane 72 forward of the ski leg mount. The ski is thus pivotally coupled to the mount such that the axis of rotation of the ski is slightly angled so as to intersect with the plane of the ski forward of the ski leg mount when the ski extends horizontally. Ski 40 is pivotally coupled to ski leg mount 136 so as to enable the ski to rotate about axis of rotation 92 generally parallel and in this example slightly angled relative to the z axis of the ski when the ski extends horizontally.

As seen in FIG. 5, steering mechanism 88 includes a third crank, in this example a first bell crank 144 per side 42 of snowmobile 30. The first bell crank is generally L-shaped in front/rear profile. First bell crank 144 includes a central portion 146, a first arm 148 coupled to and extending outwards from the central portion thereof, and a second arm 150 coupled to and extending outwards from the central portion thereof. The second arm of the first bell crank is angularly spaced-apart from the first arm of the first bell crank. First arm 148 of first bell crank 144 extends generally parallel to longitudinal axis 142 of ski leg mount 136 in this example when handlebar 56 seen in FIG. 1 is a non-turning or straight position. Second arm 150 of the first bell crank extends radially outwards from the longitudinal axis of the ski leg mount.

Central portion 146 of first bell crank 144 pivotally couples to ski leg mount 136 adjacent proximal end 138 of the ski leg mount in this example; however, this is not strictly required. The central portion of the first bell crank rotates about an axis 147 which extends parallel to axis of rotation 92. First arm 148 of first bell crank 144 pivotally couples to distal end 132 of drag link 128, in this example via a ball joint 152; however, the latter is not strictly required.

Still referring to FIG. 5, steering mechanism 88 includes a fourth crank, in this example a second bell crank 154 per side 42 of snowmobile 30. The second bell crank is generally L-shaped in front/rear profile. Second bell crank 154 may be referred to as a ski leg crank and may be said to comprise ski leg 86 in this example. The second bell crank includes a central portion 156, a first arm 158 coupled to and extending outwards from the central portion thereof, and a second arm 160 coupled to and extending outwards from the central portion thereof. The second arm of the second bell crank is angularly spaced-apart from the first arm of the second bell crank. First arm 158 of second bell crank 154 couples to ski 40. First arm 158 of second bell crank 154 extends generally parallel to longitudinal axis 142 of ski leg mount 136 in this example when handlebar 56 seen in FIG. 1 is a non-turning or straight position. Second arm 160 of the second bell crank extends radially outwards from the longitudinal axis of the ski leg mount.

Central portion 156 of second bell crank 154 pivotally couples to ski leg mount 136 adjacent distal end 140 of the ski leg mount in this example; however, this is not strictly required. The central portion of second bell crank 154 rotates about said axis of rotation 92. Steering mechanism 88 thus couples to ski leg mount 136 about one or more axes 92 and 147 that extend perpendicular to the ski leg mount in this example. The steering mechanism thus couples to the ski leg mount at a pivot point or axis of rotation which is offset upwards from ski 40 in this example. However, this is not strictly required.

Still referring to FIG. 5, steering mechanism 88 includes a rectilinear member 162 that pivotally couples together second arms 148 and 158 of bell cranks 144 and 154. The bell cranks and rectilinear member may be said to form a mechanical parallelogram or parallelogram linkage in this example. Drag link 128 thus operatively couples second arm 158 of bell crank 154 to handlebar 56 seen in FIG. 1.

In operation and referring to FIG. 1, to turn snowmobile 30 in a first or right direction 98, the handlebars are rotated to the right as shown by arrow 164. This causes steering column 104 to rotate pitman arm 110, which pulls steering linkage 112 in a forward direction 166, which rotates first crank 122 seen in FIG. 2 in a forward direction 168, rotating steering shaft 116, and causing second crank 126 seen in FIG. 3 to also move in a forward direction 170 as a result of the rotation of the steering shaft. This causes drag link 128 to move in a laterally outwards direction 172 to an extended position seen in FIG. 9, causing first bell crank 144 to rotate in clockwise direction 99 of rotation, which causes rectilinear member 162 to similarly rotate second bell crank 154 in the clockwise direction. This causes right-side edge portion 84 of ski 40 seen in FIG. 10 to angle downwards into ground 73 and causes left-side edge portion 82 of the ski to incline upwards from the ground. Turning of snowmobile 30 to the right is primarily caused by the parabolic shape of the right-side edge portion of the ski seen in FIG. 7, so engaging with the ground, with the ski so shaped and positioned thereby promoting rotation of the snowmobile towards the right. As seen in FIG. 10, ski 40 is thus biased to rest on right-side longitudinal peripheral portion thereof portion when the steering mechanism is steered in the right-hand direction.

As seen in FIG. 9, the axis of rotation of the steering mechanism so configured further causes the forward portion of the ski to move towards the direction of the turn 98 i.e. causing a slight rotation of the ski in the direction of rotation of handlebar 56 seen in FIG. 1. The slight rotation of ski 40 is about vertical plane 77 seen in FIG. 10 and y axis of the ski, as seen in FIG. 9 by z axis of ski 40 being angled laterally inwards in a forward direction by angle β₁ relative to longitudinal axis 71 of snowmobile 30. Steering mechanism 88 so configured thus provides secondary or supplementary assistance in steering in the right direction.

Referring back to FIG. 1, to turn snowmobile 30 in the left direction 100, the handlebars are rotated to the left as shown by arrow 178. This causes steering column 104 to rotate pitman arm 110, which pushes steering linkage 112 in a rearward direction 180, which rotates first crank 122 seen in FIG. 2 in a rearward direction 182, rotating steering shaft 116, and causing second crank 126 seen in FIG. 3 to also move in a rearward direction 184 as a result of the rotation of the steering shaft. This causes drag link 128 to move in a laterally inwards direction 186 to a retracted position seen in FIG. 13, causing first bell crank 144 to rotate in counter-clockwise direction 101 of rotation, which causes rectilinear member 162 to similarly rotate second bell crank 154 in the counter-clockwise direction. This causes left-side edge portion 82 of ski 40 seen in FIG. 14 to angle downwards into ground 73 and causes right-side edge portion 84 of the ski to incline upwards from the ground. Turning of snowmobile 30 to the left is primarily caused by the parabolic shape of the left-side edge portion of the ski seen in FIG. 7, so engaging with the ground, with the ski so shaped and positioned thereby promoting rotation of the snowmobile towards the left. Referring back to FIG. 14, ski 40 is thus biased to rest on left-side longitudinal peripheral portion thereof portion when the steering mechanism is steered in the left-hand direction.

As seen in FIG. 13, the axis of rotation of the steering mechanism so configured further causes the forward portion of the ski to move towards the direction of the turn 100 i.e. causing a slight rotation of the ski in the direction of rotation of handlebar 56 seen in FIG. 1. The slight rotation of ski 40 is about vertical plane 77 seen in FIG. 14 and y axis of the ski, as seen in FIG. 13 by z axis of ski 40 being angled laterally outwards in a forward direction by angle (32 relative to longitudinal axis 71 of snowmobile Steering mechanism 88 so configured thus provides secondary or supplementary assistance in steering in the right direction. The steering mechanism is primarily a mechanism for steering via angling the skis on respective inner or outer parabolic side edge portions 82 and 84 thereof seen in FIG. 7, with the axis of rotation 92 seen in FIG. 6 so angled providing an unforeseen benefit providing some rotation about the y axis. Thus, rotation of handlebar 56 in a clockwise direction 164 results in skis 40 angling towards right side edge portions 92 thereof seen in FIG. 9 in this example. Rotation of the handlebar in counter-clockwise direction 178 seen in FIG. 1, results in the skis angling towards left side edge portions 90 thereof seen in FIG. 13 in this example.

Referring to FIG. 7, width W of central portion 80 is more narrow relative to that tip 76, tail 78 or the rest of forward portion 74 or rearward portion 75 for a given length L of ski. The more narrow width W of central portion 80 is relative to that the tip, tail or the rest of forward portion or rearward portion of the for a given length L thereof, the more dramatic or responsive may be the ski to turning, resulting in a tighter radius of turn. The greater the radius of curvature of side edge portions 82 and 84 of skis, the more dramatic or responsive may be the ski to turning, here too resulting in a tighter radius of turn. When travelling in more compact snow, a tight radius of turn provided in one or more of the above manners may be desirable, resulting in snowmobile 30 that is more responsive.

When travelling in soft snow and/or lots of powder snow, a less responsive snowmobile may be preferable, such as one with skis 40 where width W of central portion 80 thereof is similar to that tip 76, tail 78 or the rest of forward portion 74 or rearward portion 75 of the for a given length L thereof. Side edge portions 82 and 84 of the skis may be relatively straight and parallel to axis z of the ski in this example. Lift is generated by upward-bending tips 76 of the skis (similar to water skiing) and when the skis are rolled onto respective ones of their left or right side edge portions, the lift is to the left or right respectively and promotes turning of snowmobile 30.

Users of traditional-turning snowmobiles (i.e. with skis which turn by rotating about y axes thereof) may lean into a turn to facilitate turning. However, when travelling in powder with such snowmobiles, the tips of the skis may get stuck in powder in the direction of the turn, inhibiting the ability of the operator to lean into the turn. To avoid this affect, snowmobile skis in powder may be initially counter-steered (ie steered in a direction opposite the direction of the desired turn) to enable the user to lean in the direction of the turn. Snowmobile skis including forward portions thereof may be traditionally relatively small to prevent the ski tips from lodging into powder and inhibiting leaning and thus turning. The rearward portions of traditional snowmobile skis may also be relatively small as the tails thereof stick out in the opposite direction of the turn, which may also inhibit leaning of the machine.

Referring to FIG. 9, steering assembly 54 as herein described (with steering configured to be primarily as a result angling the skis on respective side edge portions 82 and 84 thereof) results in skis 40 which may be more in line with framing 32 of snowmobile and longitudinal axis 71 of the snowmobile, generally parallel or slightly angled relative to the latter. The skis of the steering assembly so configured generally stay parallel to or at a slight angle to the direction of travel. The steering assembly so configured may thus enable forward portion 74 and/or rearward portion 75 of the skis of the snowmobile to be longer compared to conventional snowmobile skis (using conventional steering about y axes of the skis with the skis angling more outwards from the snowmobile). For example, skis 40 using steering assembly 54 as herein described may be up to at least 1.5 times longer (e.g. 150 cm in length instead of 100 cm in length).

Traditional snowmobile skis may also be relatively narrow to facilitate user leaning of the snowmobile in the direction of the turn, particularly in heavy snow or powder conditions where leaning may be required to affect the turn. Wider skis may not be commonly used in such cases as wider skis may make a snowmobile less tippy and thus make leaning of the snowmobile more difficult. In contrast, steering assembly 54 as herein described (with steering configured to be primarily as a result angling skis 40 on respective side edge portions 82 and 84 thereof) may reduce or eliminate the need for users to also lean snowmobile 30 in the direction of the turn. Thus, the steering assembly as herein described may enable the skis thereof to be wider than conventional snowmobile skis using conventional steering about y axes of the skis. The wider the ski (so accommodated by steering assembly 54 as herein described), the more lift may be created, with the steering assembly so configured thus enabling turning in heavy snow or powder conditions to be further facilitated. Skis 40 using steering assembly 54 as herein described may be two to three times wider than skis for snowmobiles using conventional steering. The skis may be have a width of equal to or greater 10 cm and equal to or less than 40 cm for example. Skis may have a width of 15 cm in one non-limiting preferred example.

Traditional snowmobile skis may also be relatively close together to facilitate user leaning of the snowmobile in the direction of the turn, particularly in heavy snow or powder conditions where leaning may be required to affect the turn. In contrast, because steering assembly 54 as herein described may reduce or eliminate the need for users to also lean snowmobile 30 in the direction of the turn, the distance of separation between respective skis 40 may be larger, with snowmobile 30 having a wider stance compared to conventional snowmobiles. The larger the distance of separation between the skis, the more stable may be the snowmobile and the less likely it may be to roll. Snowmobile 30, with its steering assembly 54 as herein described, may thus be more stable and thus safer compared to traditional snowmobiles.

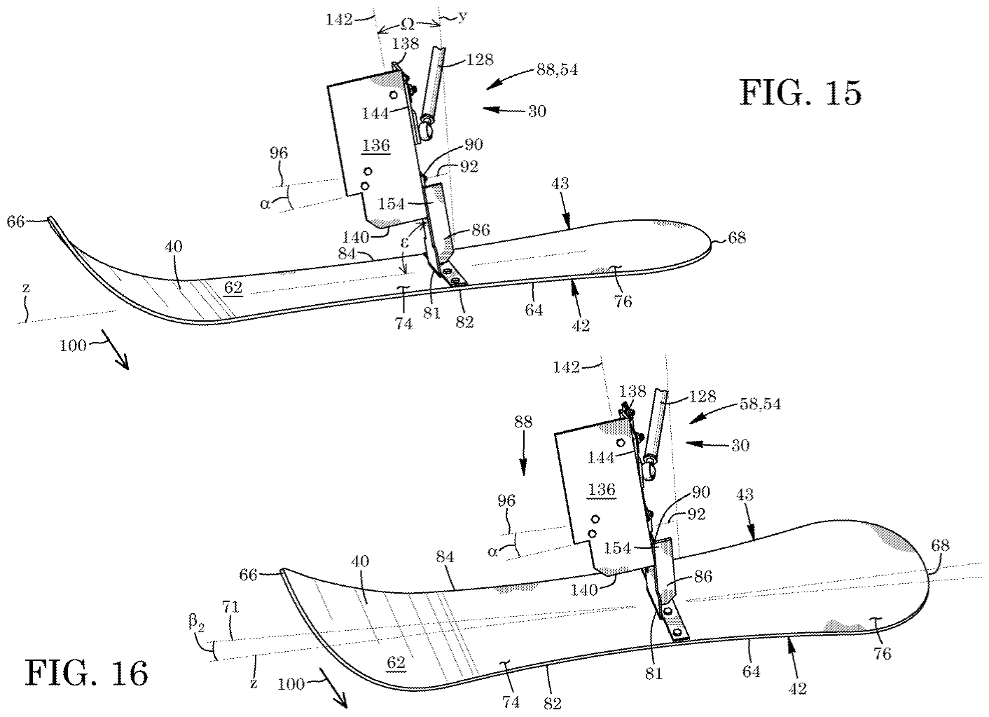

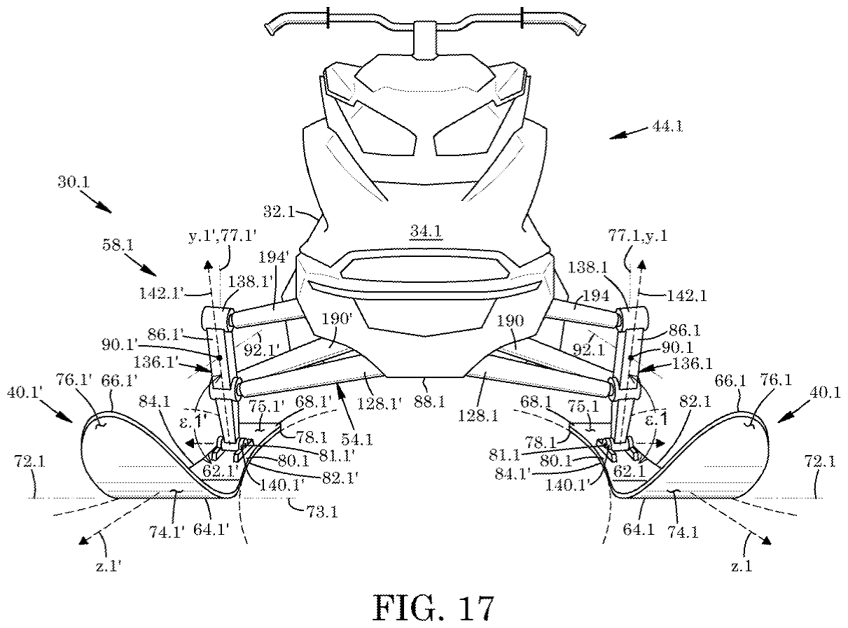

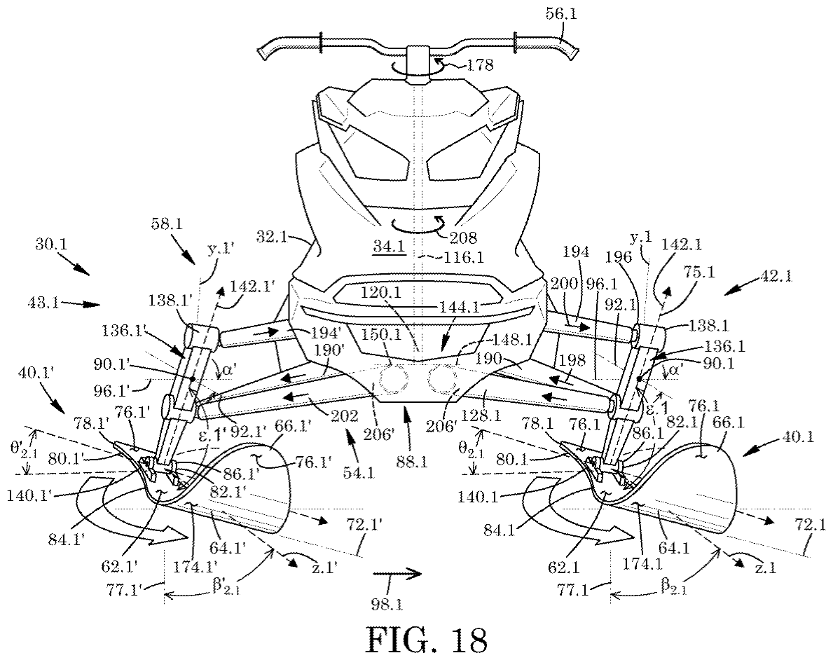

FIGS. 17 and 18 show a snowmobile 30.1 and snowmobile steering assembly 54.1 therefor according to another aspect. Like parts have like numbers and functions as the snowmobile 30 and snowmobile steering assembly 54 shown in FIGS. 1 to 16 with the addition of decimal extension “0.1”. Snowmobile 30.1 and snowmobile steering assembly 54.1 therefor are substantially the same as snowmobile 30 and snowmobile steering assembly 54 therefor shown in FIGS. 1 to 16 with at least the following exceptions.

Ski leg mounts 136.1 and 136.1′ pivotally coupled to ski legs 86.1 and 86.1′ to enable rotation of skis 40.1 and 40.1′ about planes 77.1 and 77.1′ and at least in part about y.1 and y.1′ axes.

Steering mechanism 88.1 for each ski 40.1 in this example comprises an axis of rotation 92.1 between proximal end 138.1 and distal end 140.1 of its respective ski leg mount 136.1.

A schematic non-limiting example of steering mechanism 88.1 for each ski 40.1 comprises one or more lower linkage members, in this example lower drag links 128.1 and 190 pivotally coupled to respective ski leg mount 136.1, in this example via ball joints 192; however, the latter is not strictly required. The lower drag links couple to the ski leg mount between proximal end 138.1 and distal end 140.1 of the ski leg mount in this example. Steering mechanism for each ski 40.1 thereof includes at least one upper linkage member, in this example an upper drag link 194 pivotally coupled to respective ski leg mount 136.1, in this example via a ball joint 196; however, the latter is not strictly required.

As seen in FIG. 18, rotation of handlebar 56.1 in a first or left direction 98.1 causes lower drag links 128.1 and 190 to move in a second or opposite direction, in this example right direction 198, and upper drag link 194 to move in the left direction 200. This also causes lower drag links 128.1′ and 190′ for ski 40.1′ to move the left direction 202 and upper drag link 194′ to move in the right direction 204. This movement of drag links causes ski leg mounts 136.1 and 136.1′ and thus skis 40.1 and 40.1′ to pivot about axes of rotation 92.1 and 92.1′, enabling the skis and snowmobile 30.1 to turn to the left in a manner as previously described.

Rotation of the handlebar 56.1 in the second or right direction 100.1 causes drag link members 128.1, 190, 128.1′ and 190′ to move in reverse directions, enabling the skis and snowmobile to turn to the right in a manner as previously described.

The following is a non-limiting, schematic example of a linkage system that enables steering mechanism 88.1 to move in this manner. The steering mechanism includes a crank mechanism, in this example a bell crank 144.1 coupled to distal end portion 120.1 of steering shaft 116.1. The bell crank includes a first arm 148.1 and a second arm 150.1 to which proximal ends 206 and 206′ of respective lower drag link 128.1 and 128.1′ pivotally couple. Rotation of handlebar 56.1 in direction 178 causes steering shaft 116.1 to rotate in direction 208 which via bell crank 144.1 causes drag links 128.1, 190 and 194.1′ to retract and drag links 128.1′, 190′ and 194.1 to extend. This in turn causes skis 40.1 and 40.1′ to rotate about axes of rotation 90.1 and 90.1′. This causes left side edge portions 82.1 and 82.1′ of skis 40.1 and 40.1′ to engage ground 73.1 to promote steering of snowmobile 30.1 to in left direction 98.1. Ski leg mounts 136.1 and 136.1′ are configured such that axes of rotation are angled slightly in the forwards direction so as to intersect z axes of the skis when extending horizontally and plane 72.1 forward thereof. This causes forward portions 74.1 of skis 40.1 and 40.1′ to rotate slightly relative toy axes of the skis, further functioning in a supplementary and secondary manner to promote turning of snowmobile 30.1.

Steering handlebar 56.1 in the opposite direction causes steering shaft 116.1 and bell crank 144.1 to rotate in opposite directions, with drag links 128.1, 190 and 194.1′ to retract and drag links 128.1′, 190′ and 194.1 to extend.

It will be appreciated that many variations are possible within the scope of the invention described herein. For example, ski leg mount 136 seen in FIG. 6 is shown angled upwards and slightly forwards relative to y axis of the ski when extending horizontally. Alternatively, the ski leg mount may be angled upwards and slightly rearwards relative to the y axis. In this case forward portion 74 of ski seen in FIG. 11 may angle upwards and laterally outwards in a direction opposite the direction of the turn. Further variations of described in U.S. Patent Application No. 62/457,080 filed on 9 Feb. 2017, the disclosure of which is incorporated herein by reference.

Where a component (e.g. an assembly, member, device etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### Additional Description

Examples of snowmobile steering assemblies have been described. The following clauses are offered as further description.
(1) A snowmobile steering assembly comprising: at least one ski spanning a plane, the ski having a pair of side edge portions which are outwardly concave; and a mount which pivotally couples to the ski at a pivot point and rotates the ski about an axis generally parallel to the ski.
(2) A snowmobile steering assembly comprising: at least one ski spanning a plane, the ski having a pair of side edge portions which are outwardly concave; and a mount which pivotally couples to the ski at a pivot point and rotates the ski about an axis which intersects with a plane of the ski forward of the mount when the ski extends horizontally.
(3) A snowmobile steering assembly according to any one of clauses 1 to 2, or any preceding or subsequent clause, wherein the ski has a longitudinal axis and wherein the steering mechanism is configured to primarily turn the snowmobile by selectively rotating the ski about at least in part about said longitudinal axis.
(4) A snowmobile steering assembly comprising: at least one ski having a longitudinal axis and a pair of side edge portions which are outwardly concave; and a steering mechanism pivotally coupling to the ski at a pivot point and rotates the ski about an axis generally parallel to the longitudinal axis of the ski.
(5) A snowmobile steering assembly comprising: at least one ski having a longitudinal axis and a pair of side edge portions which are outwardly concave; and a steering mechanism which rotates the ski about an axis of rotation generally parallel but slightly angled relative to the longitudinal axis of the ski when the ski extends horizontally.
(6) A snowmobile steering assembly according to any one of clauses 4 to 5, or any preceding or subsequent clause, wherein the axis of rotation extends in a generally horizontal direction.
(7) A snowmobile steering assembly comprising: at least one ski spanning a plane, the ski having a pair of side edge portions which are outwardly concave; and an elongate member coupling to and extending at least in part upwards from the ski; and a steering mechanism to which the elongate member pivotally couples about an axis extending perpendicular to the elongate member.
(8) A snowmobile steering assembly comprising: at least one ski spanning a plane, the ski having a pair of side edge portions which are outwardly concave; and an elongate member coupling to and extending at least in part upwards from the ski; and a steering mechanism to which the elongate member pivotally couples about an axis which intersects with the plane forward of the elongate member when the ski extends horizontally.
(9) A snowmobile steering assembly according to any one of clauses 7 to 8, or any preceding or subsequent clause, wherein the elongate member extends upwards and forwards at least in part from the ski when the ski extends horizontally.
(10) A snowmobile steering assembly according to any one of clauses 7 to 9, or any preceding or subsequent clause, wherein the elongate member extends along an axis that is at least slightly angled relative to the vertical axis when the ski extends horizontally.
(11) A snowmobile steering assembly according to clauses 7 to 10, or any preceding or subsequent clause, wherein the elongate member is angularly spaced relative to a front portion of the ski by at a non-perpendicular angle when the ski extends horizontally.
(12) A snowmobile steering assembly according to clause 11, or any preceding or subsequent clause, wherein said angle is an acute said angle.
(13) A snowmobile steering assembly according to clause 7 to 12, or any preceding or subsequent clause, wherein the axis extends generally horizontally.
(14) A snowmobile steering assembly comprising: at least one ski spanning a plane, the ski having a pair of side edge portions which are outwardly concave; and an elongate member fixedly coupled to and extending upwards and forwards from the ski when the ski extends horizontally; and a steering mechanism to which the elongate member pivotally couples.
(15) A snowmobile steering assembly according to clause 14, or any preceding or subsequent clause, wherein the steering mechanism couples to the elongate member about an axis which extends perpendicular to the elongate member.
(16) A snowmobile steering assembly according to clause 14, or any preceding or subsequent clause, wherein the steering mechanism couples to the elongate member at a pivot point offset upwards from the ski.
(17) A snowmobile steering assembly comprising: at least one ski having a longitudinal axis and a pair of side edge portions which are outwardly concave; and a steering mechanism configured to primarily turn the snowmobile by rotating the ski in the direction of the turn at least in part about the longitudinal axis and secondarily turn the snowmobile by rotating a forward portion of ski in the direction of the turn about a vertical axis
(18) A snowmobile steering assembly comprising: at least one ski having a longitudinal axis and a pair of side edge portions which are outwardly concave; a ski leg coupled to and extending upwards from the ski; a mount to which the ski leg pivotally couples to enable the ski to rotate about an axis of rotation parallel or slightly angled relative to the longitudinal axis of the ski when the ski extends horizontally; a steering member rotatably coupled to the snowmobile; and a linkage assembly configured to translate rotation of the steering member to rotation of the ski about said axis of rotation.
(19) A snowmobile steering assembly of clause 18, or any preceding or subsequent clause, wherein the ski leg pivotally couples to the mount about said axis of rotation.
(20) A snowmobile steering assembly according to clause 18, or any preceding or subsequent clause, wherein the linkage assembly includes a ski leg crank coupled to the ski leg and rotatable about said axis of rotation, wherein the linkage assembly includes a bell crank pivotally coupled to the mount, the bell crank including a first arm and a second arm angularly spaced from the first arm thereof, wherein the linkage assembly including a rectilinear member via which the ski leg crank and the first arm of the bell crank pivotally coupled together, and wherein the linkage assembly includes a drag link coupled to the second arm of the bell crank and operatively coupled to the steering member.
(21) A snowmobile steering assembly according to clause 20, or any preceding or subsequent clause, including a steering column coupled to the steering member and a crank via which the drag link couples to the steering column.
(22) A snowmobile steering assembly according to clause 18, or any preceding or subsequent clause, wherein the ski leg comprises a bell crank pivotally coupled to the mount, the bell crank including a first arm coupled to the ski and a second arm angularly spaced from the first arm thereof, and wherein the linkage assembly includes a drag link operatively coupling the second arm of the bell crank to the steering member.
(23) A snowmobile steering assembly according to clause 18, or any preceding or subsequent clause, wherein the ski leg comprises a first bell crank pivotally coupled to the mount, the bell crank including a first arm coupled to the ski and a second arm angularly spaced from the first arm thereof, wherein the linkage assembly includes a second bell crank pivotally coupled to the mount, the second bell crank including a first arm and a second arm angularly spaced from the first arm thereof, wherein the linkage assembly includes a rectilinear member which pivotally couples together the second arms of the bell cranks, and wherein the linkage assembly includes a drag link which pivotally couples to the first arm of the second bell crank, the drag link being responsive to rotation of the steering member.
(24) A snowmobile steering assembly comprising: at least one ski having a pair of side edge portions which are outwardly concave; and a steering mechanism pivotally coupled to the ski, the steering mechanism being configured to promote steering in a first direction by both slightly rotating the ski towards said first direction and slightly angling a forward portion of the ski towards said first direction, and the steering mechanism being configured to promote steering in a second direction opposite the first direction, by both slightly rotating the ski towards said second direction and slightly angling the forward portion of the ski towards said second direction.
(25) A snowmobile steering assembly according to clause 24, or any preceding or subsequent clause, wherein the ski includes a left-side longitudinal edge portion and a right side longitudinal edge portion spaced-apart from the first longitudinal edge portion thereof, wherein the ski is biased to rest on the left-side longitudinal edge portion thereof when the steering mechanism is steered in the first direction, and wherein the ski is biased to rest on the right-side longitudinal edge thereof portion when the steering mechanism is steered in the second direction.
(26) A snowmobile steering assembly according to clause 25, or any preceding or subsequent clause, wherein the steering mechanism turns primarily via rotation of the ski towards the first direction and the second direction, respectively.
(27) A snowmobile steering assembly according to any one of clauses 1 to 26, or any preceding or subsequent clause, wherein the ski is a parabolic said ski.
(28) A snowmobile steering assembly comprising: at least one ski extending along a longitudinal axis, the ski having a pair of side edge portions which are outwardly concave; and a steering mechanism coupling to the ski about an axis of rotation so as to cause the ski to incline towards respective one of the side edge portions thereof
(29) A snowmobile steering assembly according to clause 28, or any preceding or subsequent clause, wherein the steering mechanism couples to the ski about said axis of rotation so as to cause the forward portion of the ski to angle in part towards a direction of the turn.
(30) A snowmobile steering assembly comprising: at least one ski extending along a longitudinal axis, the ski having a pair of side edge portions which are outwardly concave; and a steering mechanism coupling to the ski about an axis of rotation that causes the ski to incline such that the side edge portion thereof opposite a direction of turn rises upwards and causes a forward portion of the ski to angle in part towards the direction of the turn.
(31) A snowmobile comprising the steering assembly of any one of clauses 1 to 31.
(32) Apparatus including any new and inventive feature, combination of features, or sub-combination of features as described herein.
(33) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A snowmobile steering assembly comprising:
at least one ski extending along a longitudinal axis, the ski having a pair of side edge portions which are outwardly concave; and
a steering mechanism configured to rotate the ski about an axis of rotation generally parallel or slightly angled relative to the longitudinal axis of the ski when the ski extends horizontally.

2. A snowmobile steering assembly according to claim 1, including a mount which pivotally couples to the ski such that the axis of rotation intersects with a horizontal plane of the ski forward of the mount.

3. A snowmobile steering assembly according to claim 1, wherein the steering mechanism is configured to primarily turn the snowmobile by selectively rotating the ski about an axis at least in part parallel to or coaxial with the longitudinal axis of the ski or the longitudinal axis of the snowmobile.

4. A snowmobile steering assembly according to claim 3, wherein the axis of rotation extends in a generally horizontal direction.

5. A snowmobile steering assembly according to claim 1, including an elongate member coupling to and extending at least in part upwards from the ski, the steering mechanism pivotally coupling to the steering mechanism about said axis of rotation.

6. A snowmobile steering assembly according to claim 5, wherein the elongate member extends upwards and forwards at least in part from the ski, with the elongate member being angularly spaced relative to a front portion of the ski by at a non-perpendicular angle when the ski extends horizontally and wherein said angle is an acute said angle.

7. A snowmobile steering assembly according to claim 5, wherein the elongate member extends along an axis that is at least slightly angled relative to the vertical axis.

8. A snowmobile steering assembly according to claim 1, wherein the ski is biased to rest on a left said side edge portion thereof when the steering mechanism is steered in a left direction, and wherein the ski is biased to rest on a right-said side edge thereof portion when the steering mechanism is steered in a right direction.

9. A snowmobile steering assembly according to claim 1, wherein the steering mechanism is pivotally coupled to the ski, wherein the steering mechanism is configured to promote steering in a first direction by both slightly inclining the ski towards said first direction and slightly angling a forward portion of the ski towards said first direction, and the steering mechanism being configured to promote steering in a second direction opposite the first direction, by both slightly inclining the ski towards said second direction and slightly angling the forward portion of the ski towards said second direction.

10. A snowmobile steering assembly according to claim 9, wherein the steering mechanism turns primarily via rotating of the ski towards the first direction and the second direction, respectively.

11. A snowmobile steering assembly according to claim 1, wherein the steering mechanism pivotally couples to the ski, wherein the steering mechanism is configured to promote steering in a left direction by both rotating the ski onto a left said side edge portion and slightly angling a forward portion of the ski towards a left direction, and wherein the steering mechanism is configured to promote steering in a right direction opposite the left direction, by both rotating the ski onto a right said side edge portion and slightly angling the forward portion of the ski towards said right direction.

12. A snowmobile steering assembly according to claim 1, including a ski leg coupled to and extending upwards from the ski at an acute angle relative to a forward portion of the ski when the ski extends horizontally.

13. A snowmobile steering assembly according to claim 12, wherein the steering assembly includes a mount coupled to framing of the snowmobile, the ski leg pivotally coupling to the mount to enable the ski to rotate about said axis of rotation parallel or slightly angled relative to the longitudinal axis of the ski when the ski extends horizontally, wherein the steering mechanism includes a steering member rotatably coupled to the snowmobile, and wherein the steering mechanism includes a linkage assembly configured to translate rotation of the steering member to rotation of the ski about said axis of rotation.

14. A snowmobile steering assembly according to claim 1, wherein the steering assembly includes a mount coupled to framing of the snowmobile, wherein the steering mechanism includes a ski leg crank coupled to the ski and pivotally coupled to the mount about said axis of rotation, wherein the steering mechanism includes a bell crank pivotally coupled to the mount, the bell crank including a first arm and a second arm angularly spaced from the first arm thereof, wherein the steering mechanism includes a rectilinear member via which the ski leg crank and the first arm of the bell crank pivotally couple together, wherein the steering mechanism includes a steering member rotatably coupled to the snowmobile, and wherein the steering mechanism includes a drag link coupled to the second arm of the bell crank and operatively coupled to the steering member.

15. A snowmobile steering assembly according to claim 14, wherein the steering mechanism includes a steering column rotatably mounted to the framing of the snowmobile, the steering column coupling to the steering member, and wherein the steering mechanism a crank via which the drag link couples to the steering column.

16. A snowmobile steering assembly according to claim 1, wherein the steering assembly includes a mount coupled to framing of the snowmobile, wherein the steering assembly includes a first bell crank pivotally coupled to the mount about said axis of rotation, the bell crank including a first arm coupled to the ski and a second arm angularly spaced from the first arm thereof, wherein the steering mechanism includes a second bell crank pivotally coupled to the mount, the second bell crank including a first arm and a second arm angularly spaced from the first arm thereof, wherein the steering mechanism includes a rectilinear member which pivotally couples together the second arms of the bell cranks, and wherein the steering mechanism includes a drag link which pivotally couples to the first arm of the second bell crank, the drag link being responsive to rotation of the steering member.

17. A snowmobile comprising the steering assembly as claimed in claim 1.

18. A snowmobile steering assembly comprising:
at least one ski spanning a plane, the ski having a pair of side edge portions which are outwardly concave;
an elongate member fixedly coupled to and extending upwards and forwards from the ski when the ski extends horizontally; and
a steering mechanism to which the elongate member pivotally couples.

19. A snowmobile steering assembly according to claim 18, wherein the steering mechanism couples to the elongate member about an axis which extends perpendicular to the elongate member.

20. A snowmobile steering assembly comprising:
at least one ski extending along a longitudinal axis, the ski having a pair of side edge portions which are outwardly concave and a top extending between said edge portions thereof; and
a steering mechanism configured to primarily turn the snowmobile by angling the top of the ski at least in part towards the direction of the turn and configured to secondarily turn the snowmobile by rotating a forward portion of ski in the direction of the turn.
